(19) United States
(12) Patent Application Publication
(10) Pub. No.: US 2012/0047799 A1
(43) Pub. Date: Mar. 1, 2012

(54) METHOD FOR OVER WINTERING ROOT CROPS

(75) Inventors: Jason STALLAERT, Chatham (CA); Kevin STALLAERT, Chatham (CA)

(73) Assignee: KEJAY INVESTMENTS INC., Chatham, ON (CA)

(21) Appl. No.: 12/862,687

(22) Filed: Aug. 24, 2010

(51) Int. Cl. A01G 1/00

(52) U.S. Cl. 47/9

(57) ABSTRACT

An over wintering method for storing mature root crops in soil in the ground in a geographic area with a seasonal climate, where the winter months are consistently below zero degrees Celsius overnight, including the steps: (a) during the fall months, positioning an impermeable material above a row of mature root crop; (b) distributing an insulating material above the impermeable material sufficient to provide an insulating layer of at least 30 centimeters in depth across the row; (c) up to six months following step (b), removing the impermeable material and the insulating material, and harvesting the root crop.

### FIELD OF THE INVENTION

The present invention relates to the field of agronomy and food storage technology, and in particular, to methods and systems for over wintering root crops.

### BACKGROUND

In cold climates, such as the one found in Southern Ontario, Canada, root crops cannot be grown year-round in the ground. As such, there is a need and opportunity to prolong root crop longevity and quality after the growing season has ended. Carrots are one such root crop where long-term, post-harvest warehouse cold storage is an issue.

Traditionally in Ontario, the carrot harvest is completed by mid-October with storage relegated to warehouses prior to sale and shipping to customers. Warehouse stock is usually sold and depleted by December. As such, the carrots grown in cold climates, such as Ontario's, cannot be stored and sold year-round using current cold storage techniques. Also, carrot quality suffers while in storage due to fungal presence, tissue dehydration leading to diminished shelf life.

In addition, cold storage requires extensive energy costs, such as electricity or natural gas, in order to maintain the proper climate to preserve the carrots for extended periods of time. Thus, the costs associated with maintaining the life of Ontario-grown carrots through cold storage warehouse techniques are significant and cost-prohibitive for some farmers.

The present invention seeks to mitigate the warehouse storage disadvantages by providing field (i.e., ground) storage of carrots through an overwintering method, and by seeking to provide optimal storage conditions in terms of temperature and humidity.

### SUMMARY OF INVENTION

In a first aspect, the present invention provides an over wintering method for storing mature root crops in soil in the ground in a geographic area with a seasonal climate, where the winter months are consistently below zero degrees Celsius overnight, including the steps: (a) during the fall months, positioning an impermeable material above a row of mature root crop; (b) distributing an insulating material above the impermeable material sufficient to provide an insulating layer of at least 30 centimeters in depth across the row; (c) up to six months following step (b), removing the impermeable material and the insulating material, and harvesting the root crop.

In a second aspect, the present invention provides a method for achieving a yield of sweeter tasting and mature carrots through use of an over wintering and seeding process in a geographic area with a seasonal climate, where the winter months are consistently below zero degrees Celsius overnight, the method including steps of: (a) during an optimal month, planting sufficient amounts of carrot seed per square area to cause adjacent carrots grown from the seed to compete for nutrients, thereby limiting carrot growth; (b) during the fall months, positioning an impermeable material above a row of mature carrots, and ensuring that each carrot head is submerged in the soil; (c) distributing an insulating material over top of the impermeable material sufficient to provide an insulation of at least 30 centimeters in depth across the row; (d) up to six months following step (c), removing the impermeable material and the insulating material, and harvesting the carrot.

In a third aspect, the present invention provides a method for over wintering a mature root crop that includes incorporating insulating material into the soil to increase residue in the soils, the method including the steps of: (a) during the fall months, positioning an impermeable material above a row of a mature root crop; (b) distributing an insulating material above the impermeable material sufficient to provide an insulation of at least 30 centimeters in depth across the row; (c) up to six months after performing step (b), removing the insulating material, while simultaneously incorporating at least a portion of said insulating material back into the soil to improve soil structure, and then removing impermeable material, and harvesting the mature root crop.

### BRIEF DESCRIPTION OF THE DRAWINGS

The embodiments of the present invention will now be described by reference to the following figures, in which identical reference numerals in different figures indicate identical elements and in which:

FIG. 1 is a cross-sectional view of two field rows of mature carrots in a field being over-wintered according to an embodiment of the present invention

FIG. 2 is a cross-sectional view of two field rows with an optimal amount of carrot seed planted therein.

### DETAILED DESCRIPTION OF THE PREFERRED EMBODIMENTS

In a preferred embodiment, the present invention is directed towards over wintering carrots; however, other root crops such as parsnips, beets, turnips, and potatoes may be over wintered using the same methods. The present invention also contemplates planting a combination of root crops.

The cold winter conditions that the invention addresses are extreme and may be found, for example, in a geographic area with arable land that spans the northern areas of the United States and the southern areas of Canada. However, the present invention is not limited to these geographic areas. The method of the present invention may be applied in a geographic area with a seasonal climate, where the winter months are consistently low enough to destroy crops, and thus warrant additional or significant insulation material.

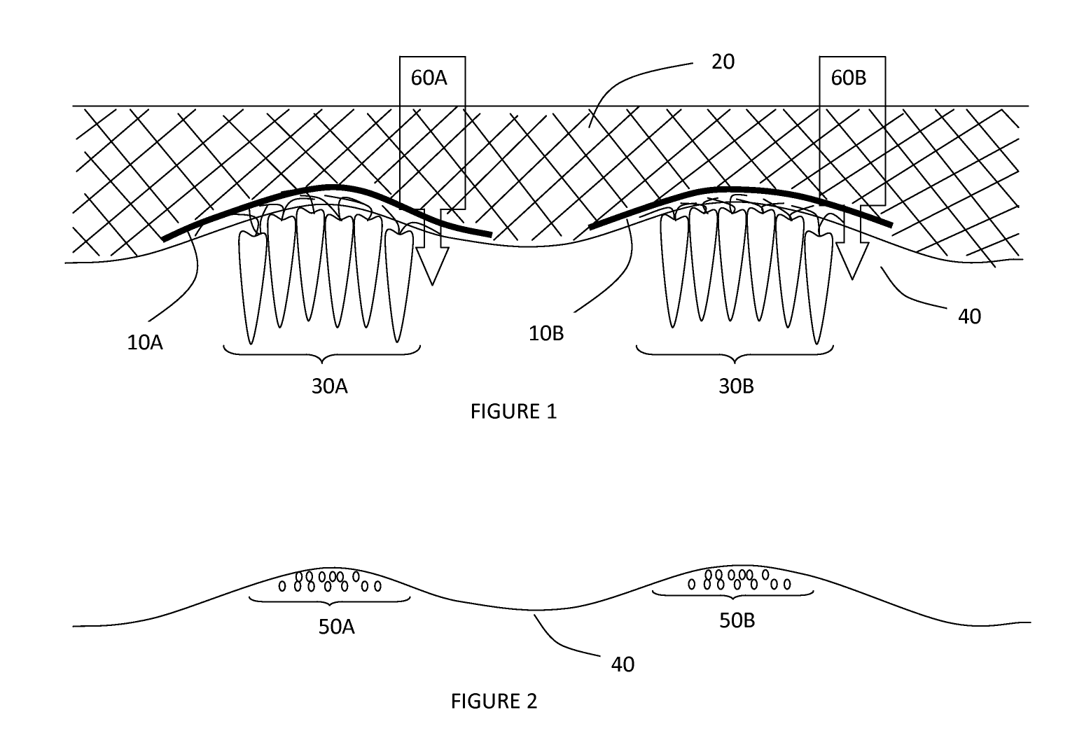

With reference now to FIG. 1, the present invention utilizes an impermeable material 10A, 10B and an insulating material 20 above the impermeable material to cover rows of mature root crops 30A, 30B that are in the ground's soil 40.

In FIG. 1, the impermeable material 10A, 10B shown is a polyethylene mulch sheeting that is UV treated and has a thickness of 1.75 mm and a width of 67 inches. Other types of material with different thicknesses and widths may be used depending on the width of the carrot rows. The insulating material 20 may be bales of straw, grass, or biodegradable plastic mulch. Any material may be used that provides suitable insulation such that the temperature underneath the impermeable material is within an acceptable range.

The present invention also contemplates using a fabric that forms both the impermeable material 10A, 10B, and the insulating material 20. Agribon™ produces a fabric that acts as a frost protection cover to about −13 degrees Celsius of frost protection. Typically, the fabric is produced in large sheets that are held in place over the crop by sandbags, for example.

According to the present invention, the method of over wintering root crops involves a one pass operation. During late fall (around November), the impermeable material 10A, 10B is spooled by a spreader machine (not shown) over top of the leaves of the mature carrots 30A, 30B in long sheets to cover a single row of carrot crops (e.g., 120 feet long by 4 feet wide). While the impermeable material is being spread, the insulating material 20 may be distributed over the impermeable material 10A, 10B using beater bars (not shown) on an implement (not shown) to the desired and approximately uniform thickness of 1 to 3 feet. Up to 6 months later, but ideally in March of the following year, the insulating material 20 and impermeable material 10A, 10B are removed.

Some insulating material 20 may also be incorporated back into the soil. Incorporating the straw or grass into the ground increases the soil residue in advantageous ways. For example, if soybeans are planted in the soil following the over wintered crops using straw or grass as the insulating material, it has been noted that fewer pesticides, chemicals, weed control, and fertilizers are required for the following soy bean crop. Soil moisture is also retained because of high organic levels.

Referring now to FIG. 2, the present invention contemplates optimizing the amount of seed 50A, 50B, distributed in the ground's soil 40. The amount of seed directly affects the size of the carrot grown. By increasing the amount of seed used per square foot of soil, the carrots do not grow as large and in turn become sweeter tasting over the winter cycle. In one preferred embodiment, about 800,000 carrot seeds per acre or about 30 carrot seeds per square foot are planted in the soil's ground. According to another preferred embodiment of the present invention, a range of about 500,000 to about 1.2 million carrot seeds per acre or about 25 to 35 carrot seeds per square foot are planted in the ground's soil. Other ranges are acceptable to limit carrot growth in such a way as to yield sweeter tasting carrots.

Returning to FIG. 1, in another embodiment of the present invention, a plurality of temperature sensors 60A, 60B are installed in the ground's soil 40, below the impermeable layer 10A, 10B, to monitor and alert growers of possible frost occurrences below the impermeable layer 10A, 10B. This monitoring is important because root crop quality will deteriorate if the frost sets in. The method of the present invention seeks to provide the root crop with an ideal relative humidity of 100% and a temperature of 0.5 degrees Celsius in the soil.

In another embodiment, the method of the present invention may include a step of carrot leaf trimming to mitigate the development of bacteria and disease presence in the carrots. The trimming would occur prior to placing the impermeable layer over top of the mature carrots. The trimming might occur in the summer months up until a few months prior to covering the mature carrots with the impermeable and insulating materials.

In another embodiment, the present invention provides an optimized over-wintering and seeding process that involves optimizing any combination of the following parameters: insulation layer configuration to mitigate carrot frost incursion; straw moisture content and sizing specifications; row heights and widths; straw load weights; carrot field row heights and widths; carrot varieties; and soil treatments.

With regard to carrot varieties, the present invention contemplates using a single variety or a combination of varieties. Florida, Niagara and Bergen are examples of carrot varieties that may be over wintered individually or in combination.

In terms of soil treatments, in a further embodiment, the present invention includes an application to the crop of a preventative fungicide, such as the one manufactured by Quadris™. This ensures that the carrots are disease free prior to the over-wintering process.

The present invention may include row heights and widths of 16 and 30 inches respectively with a 60 inch centre to centre distance between adjacent rows.

The embodiments of the invention described above are intended to be exemplary only and not a complete description of every possible configuration of any method for a method for over wintering root crops. The scope of the invention is therefore intended to be limited solely by the scope of the appended claims.

Having thus described the invention, what is claimed as new and secured by Letters Patent is:

1. An over wintering method for storing mature root crops in soil in the ground in a geographic area with a seasonal climate, where the winter months are consistently below zero degrees Celsius overnight, including the steps:
(a) during the fall months, positioning an impermeable material above a row of mature root crop;
(b) distributing an insulating material above the impermeable material sufficient to provide an insulating layer of at least 30 centimeters in depth across the row;
(c) up to six months following step (b), removing the impermeable material and the insulating material, and harvesting the root crop.

2. A method as in claim 1, wherein the root crop includes carrots.

3. A method as in claim 1, wherein the impermeable material is polyethylene sheeting.

4. A method as in claim 1, wherein the insulating material is at least one of: straw, grass, and fabric.

5. A method for achieving a yield of sweeter tasting mature carrots through use of an over wintering and seeding process in a geographic area with a seasonal climate, where the winter months are consistently below zero degrees Celsius overnight, the method including steps of:
(a) during an optimal month, planting sufficient amounts of carrot seed per square area to cause adjacent carrots grown from the seed to compete for nutrients, thereby limiting carrot growth;
(b) during the fall months, positioning an impermeable material above a row of mature carrots, and ensuring that each carrot head is submerged in the soil;
(c) distributing an insulating material above the impermeable material sufficient to provide an insulation of at least 30 centimeters in depth across the row;
(d) up to six months following step (c), removing the impermeable material and the insulating material, and harvesting the carrot.

6. A method as in claim 5, wherein the insulating material is straw.

7. A method as in claim 5, wherein the insulating material is grass.

8. A method as in claim 5, wherein the impermeable material and insulating material are a fabric.

9. A method as in claim 5, wherein step (b) further includes the step of trimming the carrot leaves prior to positioning the impermeable layer.

10. A method as in claim 5, wherein the optimized over wintering and seeding process involves optimizing at least any two of the following parameters: insulation layer configuration to mitigate carrot frost incursion; straw moisture content and sizing specifications; row heights and widths; straw load weights; carrot field row heights and widths; carrot varieties; and soil treatments.

11. A method as in claim 5, wherein the insulating layer has a consistent depth across the row of between 30 and 70 centimeters.

12. A method as in claim 5, wherein the amount of carrot seed distributed per square foot is between about 25 seeds and about 35 seeds per square foot.

13. A method as in claim 5, wherein the amount of carrot seed distributed is between about 500,000 to about 1.2 million seeds per acre.

14. A method as in claim 5, wherein step (b) includes a first step of trimming the carrot leaves to mitigate bacteria and disease presence in the mature carrots.

15. A method as in claim 5, wherein step (b) is performed in a single pass operation.

16. A method for over wintering a mature root crop that includes incorporating insulating material into the soil to increase residue in the soils, the method including the steps of:
(a) during the fall months, positioning an impermeable material above a row of a mature root crop;
(b) distributing an insulating material above the impermeable material sufficient to provide an insulation of at least 30 centimeters in depth across the row;
(c) up to six months following step (b), removing the insulating material, while simultaneously incorporating at least a portion of said insulating material back into the soil to improve soil structure, and then removing impermeable material, and harvesting the mature root crop.

17. A method as in claim 16, wherein the root crop includes carrots.
